(19) United States
(12) Patent Application Publication
(10) Pub. No.: US 2020/0339108 A1
(43) Pub. Date: Oct. 29, 2020

(54) PARKING LOT MANAGEMENT DEVICE, PARKING LOT MANAGEMENT METHOD, AND NON-TRANSITORY STORAGE MEDIUM

(71) Applicant: TOYOTA JIDOSHA KABUSHIKI KAISHA, Toyota-shi (JP)

(72) Inventors: Kazuaki TAKEMURA, Nagoya-shi (JP); Makoto MATSUSHITA, Ichinomiya-shi (JP); Tae SUGIMURA, Miyoshi-shi (JP); Hideo HASEGAWA, Nagoya-shi (JP); Tomoaki UMEKI, Toyota-shi (JP)

(73) Assignee: TOYOTA JIDOSHA KABUSHIKI KAISHA, Toyota-shi (JP)

(21) Appl. No.: 16/814,383

(22) Filed: Mar. 10, 2020

(30) Foreign Application Priority Data
Apr. 23, 2019 (JP) 2019-082059

(51) Int. Cl. B60W 30/06; G05D 1/00; G05D 1/02; B60W 60/00

(52) U.S. Cl. CPC B60W 30/06; G05D 1/0088; G05D 2201/0213; B60W 60/001; G05D 1/0212

(57) ABSTRACT

A parking lot management device includes a memory and a processor that includes hardware. The processor is configured to select a first parking position in a parking lot for a vehicle which is able to travel autonomously and from which an occupant has alighted in an alighting space provided in an entrance of the parking lot, to cause the vehicle to travel autonomously from the alighting space to the first parking position and to park at the first parking position by transmitting information of the first parking position to the vehicle, and to cause the vehicle to travel autonomously from the first parking position to the second parking position and to park at the second parking position based on information which is received from a terminal which is carried by the occupant.

### INCORPORATION BY REFERENCE

The disclosure of Japanese Patent Application No. 2019-082059 filed on Apr. 23, 2019 including the specification, drawings and abstract is incorporated herein by reference in its entirety.

### BACKGROUND

### 1. Technical Field

The disclosure relates to a parking lot management device, a parking lot management method, and a non-transitory storage medium.

### 2. Description of Related Art

Published Japanese Translation of PCT application No. 2018-501544 (JP-A-2018-501544) discloses an automatic parking method of causing a vehicle to move autonomously to a scheduled parking position in a parking lot.

### SUMMARY

In the automatic parking method disclosed in JP-A-2018-501544, a delivery space for a vehicle is provided in the vicinity of an exit of a parking lot. When a vehicle exits the parking lot, the vehicle is caused to move autonomously from a parking position at which the vehicle is parked to the delivery space and the vehicle is caused to wait for arrival of an occupant in the delivery space. Accordingly, for example, when a plurality of vehicles is going to exit the parking lot at the same time, the delivery space is overcrowded with vehicles on standby and vehicles may not be smoothly delivered from the parking lot.

The disclosure provides a parking lot management device, a parking lot management method, and a non-transitory storage medium that can smoothly deliver a vehicle from a parking lot.

According to the disclosure, there is provided a parking lot management device including a memory and a processor that includes hardware. The processor is configured to select a first parking position in a parking lot for a vehicle which is able to travel autonomously and from which an occupant has alighted in an alighting space provided in an entrance of the parking lot, to cause the vehicle to travel autonomously from the alighting space to the first parking position and to park at the first parking position by transmitting information of the first parking position to the vehicle, and to cause the vehicle to travel autonomously from the first parking position to a second parking position and to park at the second parking position based on information which is received from a terminal which is carried by the occupant.

Accordingly, the parking lot management device causes a vehicle arriving in an alighting space to travel autonomously from the alighting space to the first parking position and to park at the first parking position. By causing the vehicle to move to the second parking position which is different from the first parking position based on information received from an occupant of the vehicle, vehicles in the parking lot are rearranged.

In the parking lot management device according to the disclosure, the processor may be configured to receive information of the second parking position which is a parking position which is desired by the occupant from the terminal, and to cause the vehicle to travel autonomously from the first parking position to the second parking position and to park at the second parking position by transmitting information of the second parking position to the vehicle.

Accordingly, the parking lot management device performs rearrangement of vehicles in the parking lot by causing the vehicle to travel autonomously to the first parking position and to park at the first parking position and then causing the vehicle to move to the second parking position which is desired by the occupant of the vehicle.

In the parking lot management device according to the disclosure, the parking lot may be adjacent to a plurality of stores, and the processor may be configured to receive information of a store which is last used by the occupant from the terminal and to select a parking position closest to the store which is last used by the occupant in the parking lot as the second parking position, and to cause the vehicle to travel autonomously from the first parking position to the second parking position and to park at the second parking position by transmitting information of the second parking position to the vehicle.

Accordingly, the parking lot management device performs rearrangement of vehicles in the parking lot by causing the vehicle to travel autonomously to the first parking position and to park at the first parking position and then causing the vehicle to move to the second parking position closest to a store which is last used by the occupant of the vehicle.

In the parking lot management device according to the disclosure, the processor may be configured to further receive information of a return time at which the occupant returns to the parking lot from the terminal, and cause the vehicle to travel autonomously from the first parking position to the second parking position and to park at the second parking position in time for the return time by transmitting information of the second parking position and information of the return time to the vehicle.

Accordingly, the parking lot management device causes the vehicle to move from the first parking position to the second parking position in time for the return time at which the occupant of the vehicle returns to the parking lot.

According to the disclosure, there is also provided a parking lot management method which is performed by a parking lot management device, a vehicle that is able to travel autonomously, and a terminal that is carried by an occupant of the vehicle, the parking lot management method causing a processor of the parking lot management device to perform: selecting a first parking position in a parking lot for the vehicle from which the occupant has alighted in an alighting space provided in an entrance of the parking lot; causing the vehicle to travel autonomously from the alighting space to the first parking position and to park at the first parking position by transmitting information of the first parking position to the vehicle; and causing the vehicle to travel autonomously from the first parking position to the second parking position and to park at the second parking position based on information which is received from the terminal.

Accordingly, the parking lot management method causes a vehicle arriving in an alighting space to travel autonomously from the alighting space to the first parking position and to park at the first parking position. By causing the vehicle to move to the second parking position which is different from the first parking position based on information received from an occupant of the vehicle, vehicles in the parking lot are rearranged.

According to the disclosure, there is also provided a non-transitory storage medium storing instructions that are executable by one or more processors and that cause the one or more processors to perform functions including: selecting a first parking position in a parking lot for a vehicle which is able to travel autonomously and from which an occupant has alighted in an alighting space provided in an entrance of the parking lot; causing the vehicle to travel autonomously from the alighting space to the first parking position and to park at the first parking position by transmitting information of the first parking position to the vehicle; and causing the vehicle to travel autonomously from the first parking position to the second parking position and to park at the second parking position based on information which is received from a terminal which is carried by the occupant.

Accordingly, the non-transitory storage medium storing instructions that are executable by one or more processors and that cause the one or more processors to cause a vehicle arriving in an alighting space to travel autonomously from the alighting space to the first parking position and to park at the first parking position. By causing the vehicle to move to the second parking position which is different from the first parking position based on information received from an occupant of the vehicle, vehicles in the parking lot are rearranged.

According to the disclosure, a vehicle can be caused to move to a parking position at which an occupant can easily board the vehicle by performing rearrangement of the vehicle parking in the parking lot. Accordingly, even when a plurality of vehicles is going to exit the parking lot at the same time, occupants of the vehicles can board the vehicles at individual parking positions and manually drive the vehicles to exit the parking lot. As a result, it is possible to allow the vehicles to smoothly exit the parking lot.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram schematically illustrating a parking lot management system to which a parking lot management device according to first and second embodiments of the disclosure can be applied;

FIG. 2 is a diagram schematically illustrating an example of a layout of a parking lot which is managed by the parking lot management device according to the first and second embodiments of the disclosure;

FIG. 3 is a flowchart illustrating a process sequence of a parking lot management method according to the first embodiment of the disclosure;

FIG. 4 is a diagram illustrating an example in which a vehicle is caused to move autonomously from an alighting space to a first parking position in the parking lot management method according to the first embodiment of the disclosure;

FIG. 5 is a diagram illustrating an example in which a vehicle is caused to move autonomously from the first parking position to a second parking position in the parking lot management method according to the first embodiment of the disclosure;

FIG. 6 is a flowchart illustrating a process sequence of a parking lot management method according to a second embodiment of the disclosure; and

FIG. 7 is a diagram illustrating an example in which a vehicle is caused to move autonomously from the first parking position to the second parking position in the parking lot management method according to the second embodiment of the disclosure.

### DETAILED DESCRIPTION OF EMBODIMENTS

A parking lot management device, a parking lot management method, and a program-stored non-transitory storage medium according to embodiments will be described below with reference to the accompanying drawings. Elements in the following embodiments include elements which can be easily substituted by those skilled in the art or elements which are substantially the same.

### Parking Lot Management System

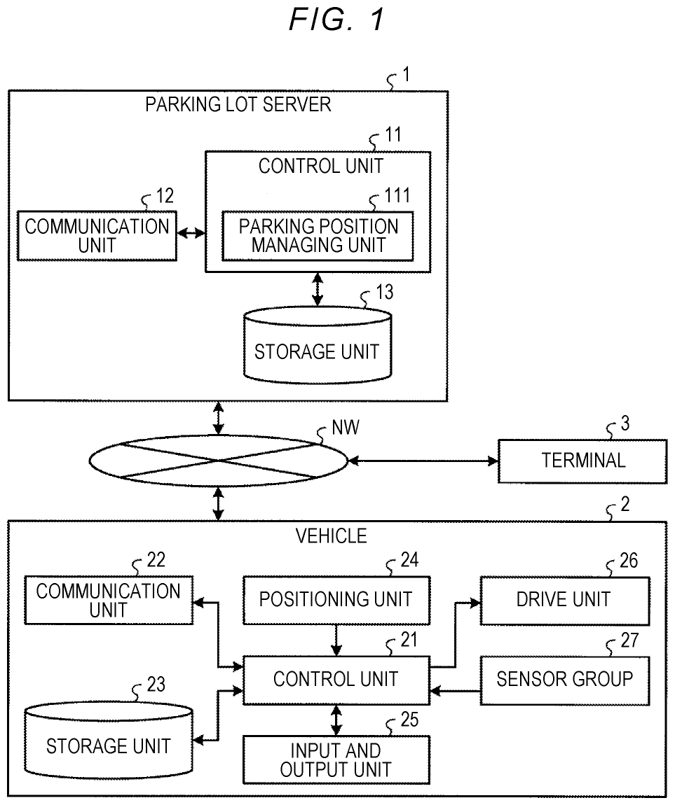

The whole configuration of a parking lot management system to which a parking lot management device according to an embodiment can be applied will be described below with reference to FIG. 1. The parking lot management system includes a parking lot server 1, one or more vehicles 2, and one or more terminals 3. The parking lot management device according to this embodiment is specifically realized by the parking lot server 1.

The parking lot server 1, the vehicles 2, and the terminals 3 can communicate with each other via a network NW. The network NW is constituted, for example, by an Internet line network or a mobile phone line network.

### Parking Lot Server

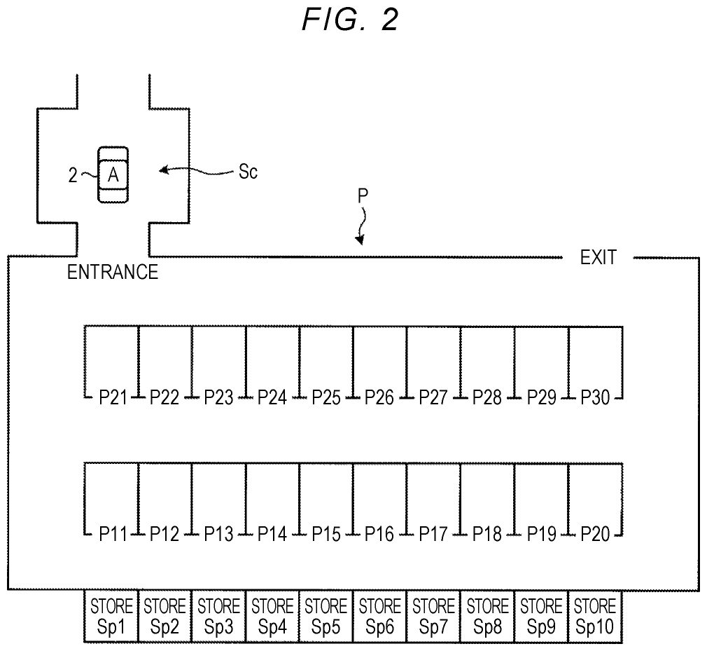

As illustrated in FIG. 2, the parking lot server 1 manages a parking lot P by causing a vehicle 2 to travel autonomously to an empty parking position in the parking lot P and to park at the empty parking position. As illustrated in FIG. 1, the parking lot server 1 includes a control unit 11, a communication unit 12, and a storage unit 13.

The control unit 11 specifically includes a processor including a central processing unit (CPU), a digital signal processor (DSP), or a field-programmable gate array (FPGA), and a memory (a main storage unit) including a random access memory (RAM) or a read only memory (ROM) (none of which are illustrated).

The control unit 11 realizes functions matching a predetermined purpose by loading a program stored in the storage unit 13 to a work area of the main storage unit, executing the loaded program, and controlling constituent units or the like through execution of the program. The control unit 11 serves as a parking position managing unit 111 by executing the program.

As illustrated in FIG. 2, the parking position managing unit 111 causes a vehicle 2 that has arrived in an alighting space Sc provided in the vicinity of an entrance of the parking lot P to travel autonomously from the alighting space Sc to a first parking position and to park at the first parking position. Then, the parking position managing unit 111 performs rearrangement of the vehicle 2 in the parking lot P by causing the vehicle 2 to move to a second parking position which is different from the first parking position based on information which is received from the terminal 3 which is carried by an occupant of the vehicle 2. A specific example of rearrangement of the vehicle 2 in the parking lot P by the parking position managing unit 111 will be described later.

Here, information on current positions of vehicles 2 (hereinafter referred to as “vehicle position information”) is periodically input to the parking lot server 1 from the vehicles 2 via the network NW. Accordingly, the control unit 11 of the parking lot server 1 can ascertain the positions of the vehicles 2 in the parking lot P normally. Information for identifying the vehicles 2 (hereinafter referred to as “vehicle information”) such as vehicle numbers of the vehicles 2, classification of ordinary vehicle/light vehicle, or vehicle models is input to the parking lot server 1 via the network NW.

The communication unit 12 includes, for example, a local area network (LAN) interface board and a radio communication circuit for radio communication. The communication unit 12 is connected to the network NW such as the Internet which is a public communication network. The communication unit 12 communicates with the vehicles 2 and the terminals 3 by accessing the network NW.

The storage unit 13 includes an erasable programmable ROM (EPROM), a hard disk drive (HDD), and a recording medium such as a removable medium. Examples of the removable medium include disc recording mediums such as a Universal Serial Bus (USB) memory, a compact disc (CD), a digital versatile disc (DVD), and a Blu-ray (registered trademark) disc (BD). An operating system (OS), various programs, various tables, various databases, and the like can be stored in the storage unit 13. For example, vehicle position information and vehicle information which are input from the vehicles 2 are stored in the storage unit 13.

### Vehicles

Each vehicle 2 is a mobile object that can communicate with the outside and that can travel autonomously (travel automatically). As illustrated in FIG. 1, the vehicle 2 includes a control unit 21, a communication unit 22, a storage unit 23, a positioning unit 24, an input and output unit 25, a drive unit 26, and a sensor group 27. The control unit 21 and the storage unit 23 are physically the same as the control unit 11 and the storage unit 13.

The control unit 21 comprehensively controls operations of various elements which are mounted in the vehicle 2. The communication unit 22 is constituted by, for example, a data communication module (DCM) and communicates with the parking lot server 1 by radio communication via the network NW.

The positioning unit 24 receives radio waves from Global Positioning System (GPS) satellites (not illustrated) and detects vehicle position information. The positioning unit 24 outputs the detected vehicle position information to the control unit 21. Accordingly, the control unit 21 outputs the vehicle position information to the parking lot server 1 via the network NW. The method of detecting vehicle position information is not limited to the method using the GPS satellites and, for example, a method using Light Detection and Ranging or Laser Imaging Detection and Ranging (LiDAR) and a three-dimensional digital map in combination may be used.

The input and output unit 25 is constituted by, for example, a touch panel display and a speaker microphone. The input and output unit 25 which serves as an output unit notifies the outside of predetermined information by displaying characters, figures, or the like on a screen of the touch panel display or outputting voice from the speaker microphone under the control of the control unit 21.

On the other hand, the input and output unit 25 serving as an input unit inputs predetermined information to the control unit 21 by allowing a user such as a driver of the vehicle 2 to operate the touch panel display or to utter voice to the speaker microphone. The vehicle 2 according to this embodiment includes the positioning unit 24 and the input and output unit 25 as different functions, but may include an onboard navigation system with a communication function having the functions of the positioning unit 24 and the input and output unit 25 together instead of the positioning unit 24 and the input and output unit 25.

The drive unit 26 is a known drive unit which is required for travel of the vehicle 2. Specifically, the vehicle 2 includes an engine as a drive source, and the engine is configured to generate electric power using an electric motor or the like by driving based on combustion of fuel. A rechargeable battery is charged with the generated electric power. The vehicle 2 includes a driving force transmission mechanism for transmitting a driving force of the engine and driving wheels for travel.

The sensor group 27 includes sensors associated with travel of the vehicle 2 such as a vehicle speed sensor and an acceleration sensor, internal sensors that can detect, for example, various situations in a passenger compartment, and an imaging device such as an image pickup camera.

### Terminals

Each terminal 3 is carried by an occupant of the vehicle 2 (for example, a driver or a passenger). The terminal 3 transmits predetermined information to the parking lot server 1 based on the occupants' input operations. Examples of the information which is transmitted from the terminal 3 to the parking lot server 1 include information of a parking position which is desired by the occupant of the vehicle 2 in the parking lot P and information of a store which is last used by the occupant of the vehicle 2 as will be described later. Although not illustrated in FIG. 1, application software (hereinafter referred to as an “application”) for transmitting and receiving information to and from the parking lot server 1 is installed in the terminal 3 and the information is transmitted to the parking lot server 1 using the application.

### Parking Lot Management Method (First Embodiment)

A parking lot management method which is performed by the parking lot management device according to the first embodiment will be described below with reference to FIGS. 2 to 5. In the following description, a parking lot management method in a case in which a vehicle 2 (vehicle A) parks at a parking position in the parking lot P as illustrated in FIG. 2 will be described. The parking lot P illustrated in the drawing is a parking lot which is adjacent to a plurality of stores Sp1 to Sp10 and includes an entrance through which a vehicle 2 enters and an exit through which the vehicle 2 exits. Parking positions of two lines each including 10 positions, that is, a total of 20 parking positions P11 to P30, are provided in the parking lot P.

An alighting space Sc in which an occupant of a vehicle 2 alights is provided in the vicinity of the entrance of the parking lot P. The occupant of the vehicle 2 alights from the vehicle 2 in the alighting space Sc and then, for example, shops in the adjacent stores Sp1 to Sp10. Then, the occupant who has completed shopping boards the vehicle 2 at a parking position which has been ascertained using a terminal 3 and manually drives the vehicle 2 to exit the parking lot P.

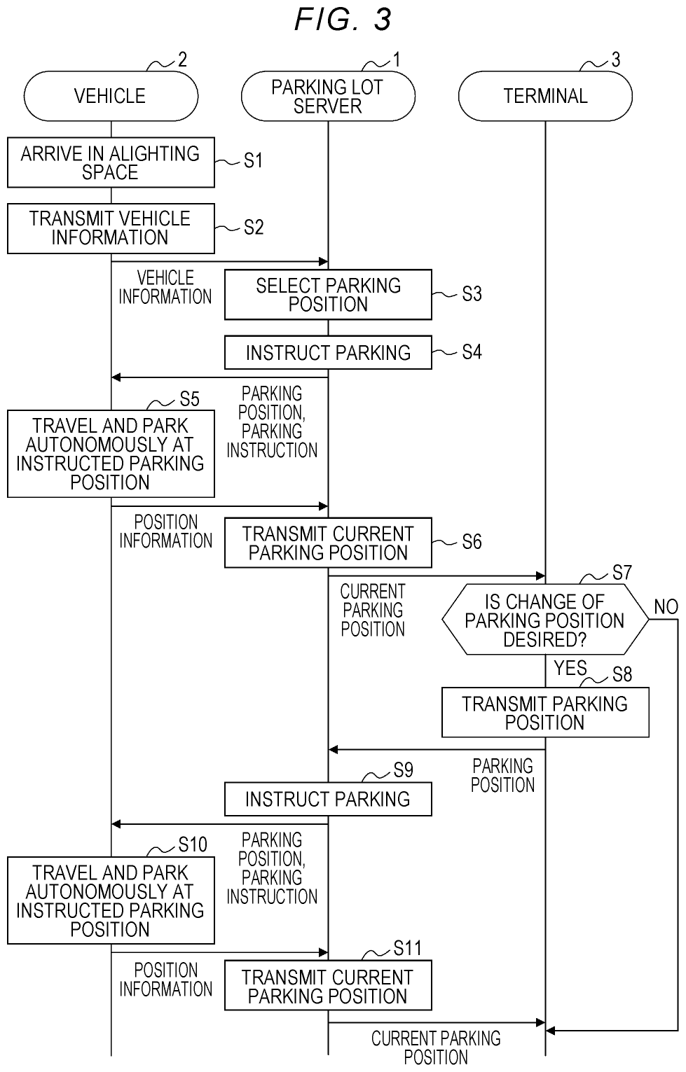

In the parking lot management method according to this embodiment, first, as illustrated in FIG. 3, the vehicle 2 arrives in the alighting space Sc which is provided in the vicinity of the entrance of the parking lot P (Step S1) and the occupant alights. Subsequently, the control unit 21 of the vehicle 2 transmits vehicle information of the vehicle 2 to the parking lot server 1 (Step S2).

Subsequently, the parking position managing unit 111 of the parking lot server 1 selects a parking position (a first parking position) in the parking lot P for the vehicle 2 from which the occupant has alighted in the alighting space Sc (Step S3). The method of selecting a parking position in Step S3 is not particularly limited. For example, the parking position managing unit 111 may randomly select an empty parking position in the parking lot P or select a parking position which satisfies one or more of the following conditions (1) to (3) out of empty parking positions in the parking lot P:
(1) a parking position which is as close to the exit as possible;
(2) a parking position which is as close to the stores Sp1 to Sp10 as possible; and
(3) a parking position at which a vehicle 2 parks on one side or both sides thereof.

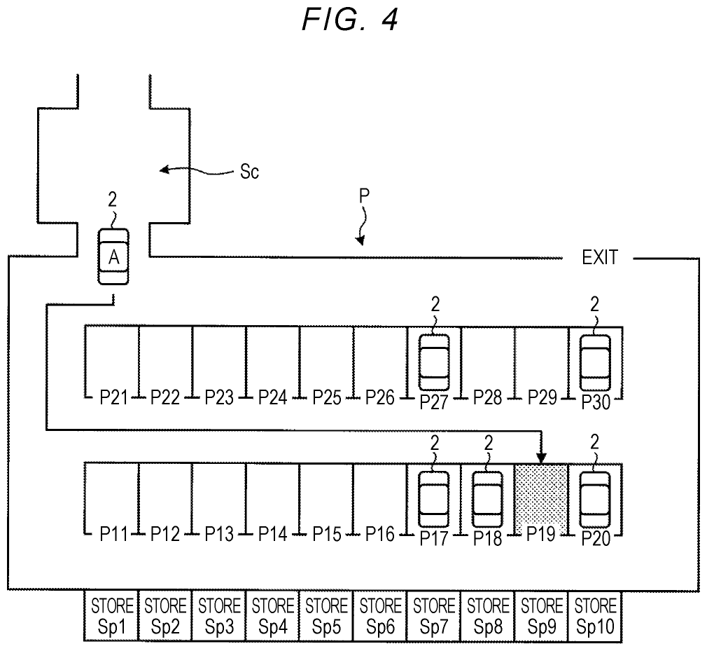

In this embodiment, as illustrated in FIG. 4, it is assumed that a parking position P19 which satisfies all of the conditions (1) to (3) is selected as the first parking position.

Subsequently, the parking position managing unit 111 transmits information of the selected parking position P19 to the vehicle 2 and instructs the vehicle 2 to park (Step S4). The information of the parking position P19 includes, for example, coordinates of the parking position P19 and a moving route to the parking position P19.

The vehicle 2 which is instructed to park travels autonomously from the alighting space Sc to the parking position P19 and parks at the parking position P19 as illustrated in FIG. 4 (Step S5). Then, the vehicle 2 transmits vehicle position information after parking to the parking lot server 1. Subsequently, the parking position managing unit 111 transmits the current parking position P19 of the vehicle 2 to the terminal 3 which is carried by the occupant of the vehicle 2 based on the received vehicle position information (Step S6).

Subsequently, the terminal 3 determines whether the occupant of the vehicle 2 desires to change the parking position (Step S7). In Step S7, the terminal 3 inquires of the occupant about whether the parking position is to be changed, for example, using an application which is not illustrated. When the occupant performs an input operation indicating that “the parking position is not to be changed” using the application, the terminal 3 determines that the occupant does not desire to change the parking position (No in Step S7) and the process sequence ends.

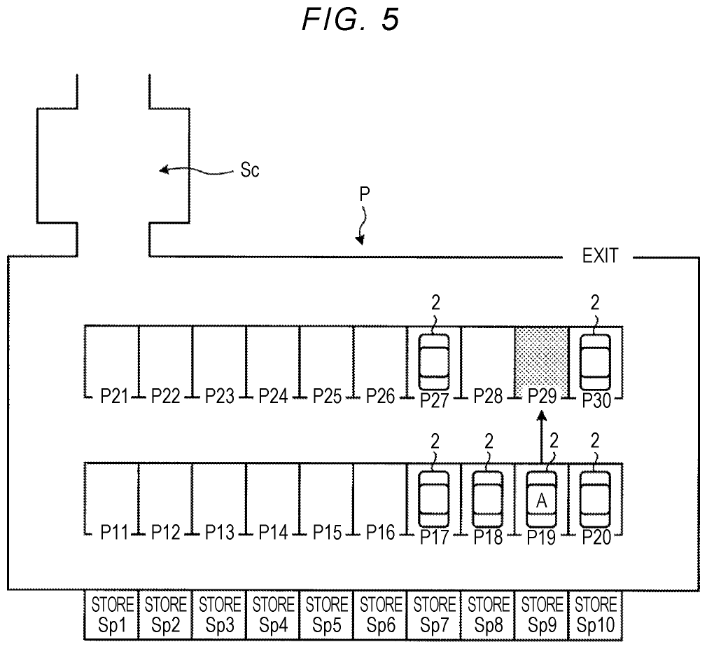

On the other hand, when the occupant performs an input operation indicating that “the parking position is to be changed” using the application, the terminal 3 determines that the occupant desires to change the parking position (Yes in Step S7). In this case, the terminal 3 presents empty parking positions in the parking lot P to the occupant, for example, using the application and allows the occupant to select one parking position. In this embodiment, as illustrated in FIG. 5, it is assumed that the parking position P29 is selected as the parking position (the second parking position) which is desired by the occupant.

Subsequently, the terminal 3 transmits information of the parking position P29 desired by the occupant to the parking lot server 1 (Step S8). Subsequently, the parking position managing unit 111 having received the information of the parking position P29 from the terminal 3 transmits the information of the parking position P29 to the vehicle 2 and instructs the vehicle 2 to park at the parking position P29 (Step S9).

As illustrated in FIG. 5, the vehicle 2 which is instructed to park travels autonomously from the parking position P19 to the parking position P29 and parks (Step S10), and transmits vehicle position information after parking to the parking lot server 1. Subsequently, the parking position managing unit 111 transmits the current parking position P29 of the vehicle 2 to the terminal 3 which is carried by the occupant of the vehicle 2 based on the received vehicle position information (Step S11) and the process sequence ends.

With the parking lot management method according to the first embodiment described above, rearrangement of the vehicle 2 in the parking lot P is performed by causing the vehicle 2 to travel autonomously to the first parking position and to park at the first parking position and then causing the vehicle 2 to move to the second parking position which is desired by the occupant of the vehicle 2. In this way, by performing rearrangement of the vehicle 2 which has parked automatically in the parking lot P, it is possible to cause the vehicle 2 to move to a parking position at which the occupant can easily board the vehicle 2. Accordingly, even when a plurality of vehicles 2 is going to exit the parking lot P at the same time, occupants can board the vehicles 2 at the individual parking positions and manually drive the vehicles 2 to exit the parking lot P. As a result, it is possible to cause the vehicles 2 to smoothly exit the parking lot P.

In the parking lot management method according to the first embodiment, for example, the terminal 3 may acquire information of a time at which the occupant returns to the parking lot P (hereinafter referred to as a “return time”) using an application which is not illustrated in advance and transmit information of the return time in addition to the information of the parking position P29 desired by the occupant to the parking lot server 1 in Step S8 in FIG. 3.

In this case, the parking position managing unit 111 having received the information of the parking position P29 and the information of the return time from the terminal 3 transmits the received information to the vehicle 2 and instructs the vehicle 2 to park at the parking position P29 (Step S9). The vehicle 2 which is instructed to park travels autonomously from the parking position P19 to the parking position P29 and parks in time for the return time (Step S10).

In this way, by transmitting the information of the return time at which the occupant returns to the parking lot P to the parking lot server 1, it is possible to perform rearrangement of the vehicle 2 in time for the return time. Since movement from the parking position P19 to the parking position P29 has only to be completed by the return time, for example, rearrangement of the vehicle 2 may be performed such that the vehicle 2 finally parks at the parking position P29 after having parked at other parking positions from the parking position P19.

### Parking Lot Management Method (Second Embodiment)

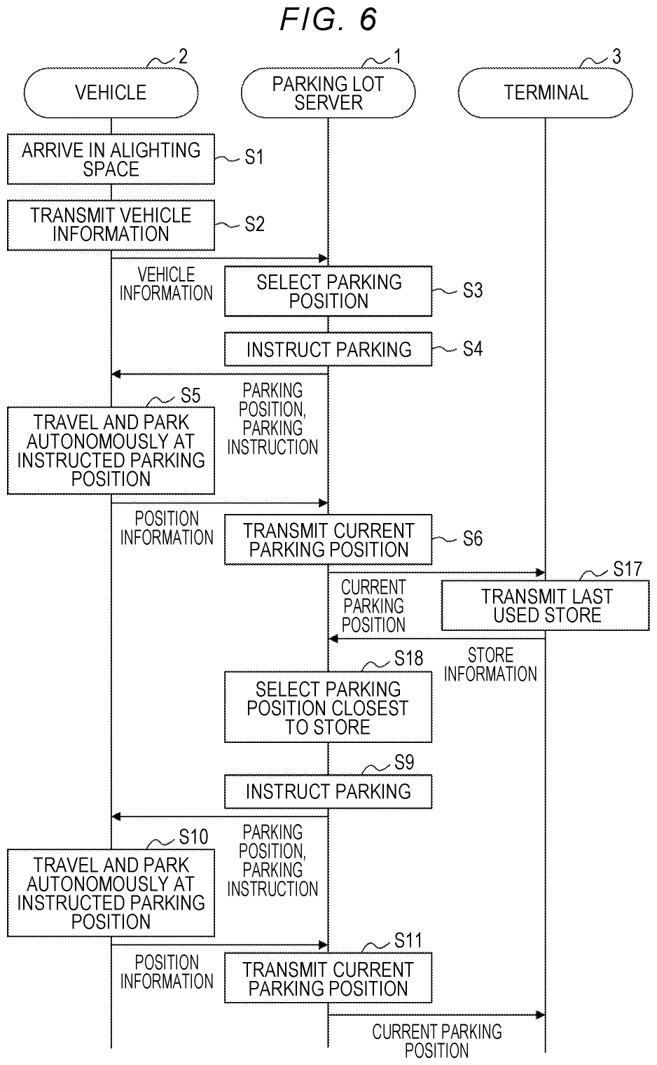

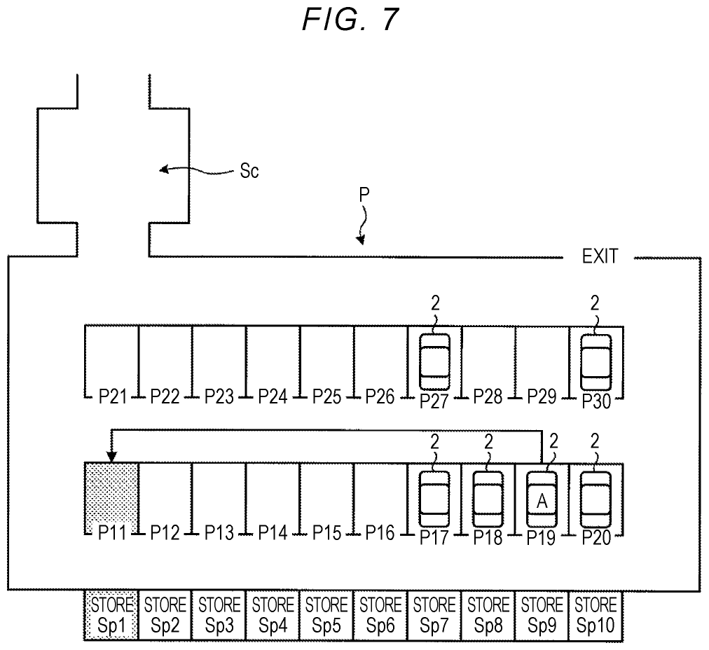

A parking lot management method which is performed by the parking lot management device according to a second embodiment will be described below with reference to FIGS. 6 and 7. In this embodiment, as illustrated in FIG. 6, Steps S17 and S18 are performed instead of Steps S7 and S8 (see FIG. 3) of the parking lot management method according to the first embodiment.

An occupant of a vehicle 2 selects a changed parking position (a second parking position) in the first embodiment, but the parking lot server 1 selects a changed parking position in this embodiment. Steps S1 to S6 and S9 to S11 of the parking lot management method according to this embodiment are the same as in the first embodiment and thus detailed description thereof will not be repeated. In this embodiment, as illustrated in FIG. 7, it is assumed that the parking position P19 is selected as the first parking position similarly to the first embodiment.

The terminal 3 having received the information of the current parking position P19 of the vehicle 2 in Step S6 transmits information of a store which is last used by the occupant of the vehicle 2 to the parking lot server 1 (Step S17). In Step S17, the terminal 3 prompts the occupant to input the store which is last used, for example, using an application which is not illustrated. Then, the terminal 3 transmits information of the store which is input by the occupant to the parking lot server 1. In this embodiment, as illustrated in FIG. 7, it is assumed that the store which is last used by the occupant is the store Sp1.

Subsequently, the parking position managing unit 111 having received the information of the store Sp1 which is last used by the occupant from the terminal 3 selects the parking position P11 which is closest to the store Sp1 in the parking lot P as the second parking position as illustrated in FIG. 7 (Step S18). Subsequently, the parking position managing unit 111 transmits the information of the parking position P11 to the vehicle 2, instructs the vehicle 2 to park at the parking position P11 (Step S9), and performs the processes of Step S10 and steps subsequent thereto.

With the parking lot management method according to the second embodiment described above, rearrangement of the vehicle 2 in the parking lot P is performed by causing the vehicle 2 to travel autonomously to the first parking position and to park at the first parking position and then causing the vehicle 2 to move to the second parking position which is closest to the store which is last used by the occupant of the vehicle 2. In this way, by performing rearrangement of the vehicle 2 which has parked automatically in the parking lot P, it is possible to cause the vehicle 2 to move to a parking position at which the occupant can easily board the vehicle 2. Accordingly, even when a plurality of vehicles 2 is going to exit the parking lot P at the same time, occupants can board the vehicles 2 at the parking positions and manually drive the vehicles 2 to exit the parking lot P. As a result, it is possible to cause the vehicles 2 to smoothly exit the parking lot P.

In the parking lot management method according to the second embodiment, for example, the terminal 3 may acquire information of a return time at which the occupant returns to the parking lot P using an application which is not illustrated in advance and transmit information of the return time in addition to the information of the store Sp1 last used by the occupant to the parking lot server 1 in Step S17 in FIG. 3.

In this case, the parking position managing unit 111 having received the information of the store Sp1 last used by the occupant and the information of the return time from the terminal 3 selects the parking position P11 closest to the store Sp1 in the parking lot P as the second parking position (Step S18), transmits the information of the parking position P11 and the information of the return time to the vehicle 2 (Step S9), and instructs the vehicle 2 to park at the parking position P11. The vehicle 2 which is instructed to park travels autonomously from the parking position P19 to the parking position P11 and parks in time for the return time (Step S10).

In this way, by transmitting the information of the return time at which the occupant returns to the parking lot P to the parking lot server 1, it is possible to perform rearrangement of the vehicle 2 in time for the return time. Since movement from the parking position P19 to the parking position P11 has only to be completed by the return time, for example, rearrangement of the vehicle 2 may be performed such that the vehicle 2 finally parks at the parking position P11 after having parked at other parking positions from the parking position P19.

New advantageous effects or modified examples can be easily derived by those skilled in the art. Accordingly, a broader aspect of the disclosure is not limited to the specific details described and illustrated above and the representative embodiments. Accordingly, the disclosure can be modified in various forms without departing from the idea or scope of the comprehensive concept of the disclosure which is defined by the appended claims and equivalents thereof.

For example, in the parking lot management methods according to the first and second embodiments, the number of vehicles 2 entering the parking lot P is one, but they can be applied to a case in which a plurality of vehicles 2 enters the parking lot P at the same time.

In the parking lot management methods according to the first and second embodiments, the parking lot P includes one floor as illustrated in FIG. 2, but the parking lot P may include a plurality of floors. When the parking lot P includes a plurality of floors, for example, the logic of the disclosure may be applied to the parking positions of all the floors of the parking lot P, and rearrangement of the vehicle 2 may be performed throughout the floors. In a parking lot P having a roof floor, a vehicle 2 parking in the roof floor may be caused to move autonomously to an indoor empty parking position, for example, in bad weather such as rain.

In the parking lot management method according to the second embodiment, the parking position P11 closest to the store Sp1 which is last used by the occupant is selected as the second parking position in Step S18, but, for example, when the parking position P11 is occupied already, the vehicle 2 may be caused to temporarily move to a parking position (for example, the parking position P12) second closest to the store Sp1 after the parking position P11 and then the vehicle 2 may be caused to move to the parking position P11 after the parking position P11 has become empty. That is, the parking position of the vehicle 2 may be changed a plurality of times such that the parking position becomes closer to the parking position P11 closest to the store Sp1.

What is claimed is:

1. A parking lot management device comprising:
a memory; and
a processor that includes hardware,
wherein the processor is configured to:
select a first parking position in a parking lot for a vehicle which is able to travel autonomously and from which an occupant has alighted in an alighting space provided in an entrance of the parking lot;
cause the vehicle to travel autonomously from the alighting space to the first parking position and to park at the first parking position by transmitting information of the first parking position to the vehicle; and
cause the vehicle to travel autonomously from the first parking position to a second parking position and to park at the second parking position based on information which is received from a terminal which is carried by the occupant.

2. The parking lot management device according to claim 1, wherein the processor is configured to:
receive information of the second parking position which is a parking position which is desired by the occupant from the terminal; and
cause the vehicle to travel autonomously from the first parking position to the second parking position and to park at the second parking position by transmitting information of the second parking position to the vehicle.

3. The parking lot management device according to claim 1, wherein the parking lot is adjacent to a plurality of stores, and
wherein the processor is configured to:
receive information of a store which is last used by the occupant from the terminal and to select a parking position closest to the store which is last used by the occupant in the parking lot as the second parking position; and
cause the vehicle to travel autonomously from the first parking position to the second parking position and to park at the second parking position by transmitting information of the second parking position to the vehicle.

4. The parking lot management device according to claim 2, wherein the processor is configured to:
further receive information of a return time at which the occupant returns to the parking lot from the terminal; and
cause the vehicle to travel autonomously from the first parking position to the second parking position and to park at the second parking position in time for the return time by transmitting information of the second parking position and information of the return time to the vehicle.

5. A parking lot management method which is performed by a parking lot management device, a vehicle that is able to travel autonomously, and a terminal that is carried by an occupant of the vehicle, the parking lot management method causing a processor of the parking lot management device to perform:
selecting a first parking position in a parking lot for the vehicle from which the occupant has alighted in an alighting space provided in an entrance of the parking lot;
causing the vehicle to travel autonomously from the alighting space to the first parking position and to park at the first parking position by transmitting information of the first parking position to the vehicle; and
causing the vehicle to travel autonomously from the first parking position to a second parking position and to park at the second parking position based on information which is received from the terminal.

6. A non-transitory storage medium storing instructions that are executable by one or more processors and that cause the one or more processors to perform functions comprising:
selecting a first parking position in a parking lot for a vehicle which is able to travel autonomously and from which an occupant has alighted in an alighting space provided in an entrance of the parking lot;
causing the vehicle to travel autonomously from the alighting space to the first parking position and to park at the first parking position by transmitting information of the first parking position to the vehicle; and
causing the vehicle to travel autonomously from the first parking position to a second parking position and to park at the second parking position based on information which is received from a terminal which is carried by the occupant.
